(19) United States
(12) Patent Application Publication
(10) Pub. No.: US 2025/0277123 A1
(43) Pub. Date: Sep. 4, 2025

(54) Ink Jet Ink Composition And Recording Device

(71) Applicant: SEIKO EPSON CORPORATION, Tokyo (JP)

(72) Inventors: Akinobu SUMIYOSHI, Shiojiri (JP); Tomoki MARUYAMA, Matsumoto (JP)

(21) Appl. No.: 19/068,330

(22) Filed: Mar. 3, 2025

(30) Foreign Application Priority Data
Mar. 4, 2024 (JP) 2024-032018

(51) Int. Cl. C09D 11/326; C09D 11/38

(52) U.S. Cl. CPC C09D 11/326; C09D 11/38

(57) ABSTRACT

An ink jet ink composition includes a pigment formed of a self-dispersing pigment A having a volume average particle diameter D50 of 150 nm or less and containing a phosphorus-containing group, and a self-dispersing pigment B having a volume average particle diameter D50 of 90 nm or greater and 150 nm or less and containing a functional group other than the phosphorus-containing group.

The present application is based on, and claims priority from JP Application Serial Number 2024-032018, filed Mar. 4, 2024, the disclosure of which is hereby incorporated by reference herein in its entirety.

### BACKGROUND

### 1. Technical Field

The present disclosure relates to an ink jet ink composition and a recording device.

### 2. Related Art

Ink jet recording has been performed in a wide range of fields. The ink jet recording has been actively employed for home and business purposes. Further, remote work and SOHO are also on the rise, and thus printing at home has also been increasing. An ink jet printer on which a large-sized ink tank is mounted is examined in terms of enabling reduction of the time and effort to replace ink cartridges and enabling continuous printing.

For example, JP-A-2015-061896 discloses an ink composition that is poured into an ink container which includes an ink chamber capable of being replenished with an ink composition and an ink filling hole capable of being opened and closed and in which the ink chamber can communicate with outside air, the ink composition containing a pigment, a resin, and an organic solvent.

An ink jet printed material exhibits inferior color development on plain paper when compared with a printing method such as an electrophotographic method. The reason for this is that a color material permeates into a recording medium with an ink so that the color material does not remain on the surface due to the characteristic of an ink jet ink composition being a liquid.

Further, when a printer is allowed to stand for a long period of time, there is a concern for printing unevenness occurring due to sedimentation of a pigment in the ink inside a tank, a cartridge, or a flow passage. In the ink containing a pigment that is likely to be sedimented, the pigment may enter a cake-like state so that blockage or the like of the flow passage is caused.

Therefore, such an ink composition is insufficient in terms of having excellent color developability and markedly suppressing sedimentation.

### SUMMARY

According to an aspect of the present disclosure, there is provided an ink jet ink composition including: a pigment formed of a self-dispersing pigment A having a volume average particle diameter D50 of 150 nm or less and containing a phosphorus-containing group, and a self-dispersing pigment B having a volume average particle diameter D50 of 90 nm or greater and 150 nm or less and containing a functional group other than the phosphorus-containing group.

According to another aspect of the present disclosure, there is provided a recording method including: jetting the ink jet ink composition from an ink jet head to make the ink jet ink composition adhere to a recording medium.

### BRIEF DESCRIPTION OF THE DRAWINGS

FIG. 1 is a perspective view schematically showing a schematic configuration of a recording device in a see-through state according to a first embodiment.

FIG. 2 is a perspective view showing an ink supply unit provided in a housing of the recording device.

FIG. 3 is a plan view showing the ink supply unit.

FIG. 4 is a partially broken cross-sectional view taken along arrow line IV-IV in FIG. 3.

FIG. 5 is a perspective view showing an ink storage container in a state where a cap is removed.

FIG. 6 is a partially broken front view showing a state where an ink replenishing operation is performed on the ink storage container.

FIG. 7 is a table (Table 1) showing formulations and the like of compositions of examples.

FIG. 8 is a table (Table 2) showing formulations and the like of compositions of examples.

FIG. 9 is a table (Table 3) showing formulations and the like of compositions of examples and comparative examples.

FIG. 10 is a table (Table 4) showing formulations and the like of compositions of comparative examples and reference examples.

### DESCRIPTION OF EMBODIMENTS

Hereinafter, embodiments of the present disclosure will be described. The embodiments described below are examples that describe the present disclosure. The present disclosure is not limited to the embodiments described below, and includes various modified forms that are implemented within a range where the scope of the present disclosure is not changed. Further, all the configurations described below are not necessarily essential configurations of the present disclosure.

### 1. Ink Jet Ink Composition

An ink jet ink composition according to the present embodiment contains a pigment formed of a self-dispersing pigment A having a volume average particle diameter D50 of 150 nm or less and containing a phosphorus-containing group, and a self-dispersing pigment B having a volume average particle diameter D50 of 90 nm or greater and 150 nm or less and containing a functional group other than the phosphorus-containing group.

The sedimentation of the pigment described above can be suppressed by using a pigment having an average particle diameter of a predetermined value or less. However, a pigment having a small average particle diameter has a low ability to remain in the vicinity of a surface of a recording medium and thus may reduce the print density. Among recording media, plain paper exhibits insufficient color developability (print density) in some cases depending on the kind thereof. The ink according to the present embodiment has an excellent property of suppressing sedimentation and excellent color developability.

### 1.1. Self-Dispersing Pigment A

The ink jet ink composition according to the present embodiment contains a self-dispersing pigment A having a volume average particle diameter D50 of 150 nm or less and containing a phosphorus-containing group.

The self-dispersing pigment is a pigment that can be dispersed and/or dissolved in an aqueous medium without a dispersant such as a resin or a surfactant. Here, the expression of “dispersed and/or dissolved in an aqueous medium without a dispersant” denotes a state where the pigment is stably present in an aqueous medium due to a hydrophilic group on the surface thereof even when a dispersant for dispersing the pigment is not used.

Since the ink jet ink composition containing a self-dispersing pigment is not required to contain a dispersant for dispersing a pigment, generation of air bubbles and degradation of defoaming properties caused by a dispersant are unlikely to occur, and thus the jetting stability is likely to be improved. Further, generation of foreign matter at a gas-liquid interface caused by a dispersant when the ink jet ink composition is dried is suppressed, and thus the jetting reliability is also excellent. Further, since a significant increase in viscosity caused by a dispersant is suppressed, the ink jet ink composition can be allowed to contain a larger amount of pigment, and as a result, the print density can be further increased.

The self-dispersing pigment tends to have slightly inferior fixing properties of an image compared to a pigment formed such that an anionic resin is physically adsorbed on the surface of pigment particles or a resin dispersing pigment dispersed in a state where an anionic resin contains a pigment, but the ink jet ink composition according to the present embodiment can exhibit excellent optical density of an image by using a combination of the self-dispersing pigment A and a self-dispersing pigment B described below.

The self-dispersing pigment A reacts with calcium when a recording medium contains calcium, and thus an image with excellent color developability is likely to be formed. The color developability is likely to be obtained in a case of the self-dispersing pigment A having a surface to which a phosphorus-containing group such as a phosphoric acid group or a phosphonic acid group is bonded. A phosphorus-containing acid group such as a phosphoric acid group or a phosphonic acid group is more preferable as the phosphorus-containing group.

A pigment obtained by bonding a hydrophilic group to the surface of the pigment directly or via other atomic groups is used as the self-dispersing pigment A, and examples thereof include a pigment obtained by bonding a functional group containing a phosphorus-containing group to the surface of the pigment particles and a pigment obtained by chemically bonding an anionic resin containing a phosphorus-containing group to the surface of the pigment particles.

Examples of the phosphorus-containing group contained in the surface of the self-dispersing pigment A include —PO₃HM and —PO₃M₂, and the surface thereof may contain other hydrophilic groups. Examples of the other hydrophilic groups include —OM, —COOM, —CO—, —SO₃M, —SO₂M, —SO₂NH₂, —RSO₂M, —SO₂NHCOR, —NH₃, —NR₃, and a group in which some hydrogen atoms of a propyleneoxy chain have been substituted with M. In the formulae, M represents a hydrogen atom, an alkali metal, ammonium, or an organic amine, and R represents an alkyl group having 1 or more and 12 or less carbon atoms or a naphthyl group which may have a substituent.

Further, examples of the other atomic groups include a linear or branched alkylene group having 1 or more and 12 or less carbon atoms, a phenylene group, a naphthylene group, an amide group, a sulfonyl group, an amino group, a carbonyl group, an ester group, an ether group, and a group obtained by combining these groups.

Examples of the self-dispersing pigment A include a pigment obtained by bonding a phosphorus-containing group to the surface of the pigment particles by a known method and a pigment obtained by bonding a functional group containing a phosphorus-containing group to the surface of the pigment particles by performing diazo coupling, and both pigments can be suitably used. The self-dispersing pigment obtained by bonding an anionic resin to the surface of the pigment particles is a pigment in which a resin having a unit containing at least a phosphorus-containing group as a hydrophilic unit is bonded to the surface of the pigment particles directly or via other atomic groups.

A phosphonic acid group is preferable as the phosphorus-containing group. Examples of the phosphonic acid group include a bisphosphonic acid group and a monophosphonic acid group. Among these, a bisphosphonic acid group is more preferable.

The pigment of a self-dispersing type is not particularly limited, and examples of the kind of pigment include an inorganic pigment such as carbon black, calcium carbonate, or titanium oxide, and an organic pigment such as an azo pigment, an isoindolinone pigment, a diketopyrrolopyrrole pigment, a phthalocyanine pigment, a quinacridone pigment, or an anthraquinone pigment.

Examples of a black pigment include No. 2300, No. 900, MCF88, No. 33, No. 40, No. 45, No. 52, MA7, MA8, MA100, and No. 2200B (all manufactured by Mitsubishi Chemical Corporation), Raven 5750, Raven 5250, Raven 5000, Raven 3500, Raven 1255, and Raven 700 (all manufactured by Columbia Carbon Co., Ltd.), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all manufactured by Cabot Corporation), and Color Black FW1, Color Black FW2, Color Black FW2V, Color Black FW18, Color Black FW200, Color black S150, Color Black S160, Color Black S170, Printex 35, Printex U, Printex V, Printex 140U, Special Black 6, Special Black 5, Special Black 4A, and Special Black 4 (all manufactured by Degussa-Huls AG).

Examples of a white pigment include C.I. Pigment White 1 (basic lead carbonate), 4 (zinc oxide), 5 (mixture of zinc sulfide and barium sulfate), 6 (titanium oxide), 6:1 (titanium oxide containing other metal oxides), 7 (zinc sulfide), 18 (calcium carbonate), 19 (clay), 20 (titanium mica), 21 (barium sulfate), 22 (natural barium sulfate), 23 (gloss white), 24 (alumina white), 25 (gypsum), 26 (magnesium oxide/silicon oxide), 27 (silica), and 28 (anhydrous calcium silicate).

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Examples of pigments of colors other than black, white, yellow, magenta, and cyan include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Further, examples of color pigments include phthalocyanine-based pigments, azo-based pigments, anthraquinone-based pigments, azomethine-based pigments, and fused ring-based pigments in addition to Pigment yellow Series, Pigment Red Series, Pigment Violet Series, and Pigment Blue Series listed in the color index. Further, other examples thereof include organic pigments such as Yellow No. 4, No. 5, No. 205, and No. 401, Orange No. 228 and No. 405, and Blue No. 1 and No. 404, and inorganic pigments such as titanium oxide, zinc oxide, zirconium oxide, iron oxide, ultramarine, Prussian blue, and chromium oxide.

The above-described pigments can be defined as the pigments obtained by bonding a phosphorus-containing group to the surface of the particles directly or via other atomic groups.

For example, when carbon black is used as the self-dispersing pigment A, the self-dispersing pigment B is produced by, for example, performing a physical treatment or a chemical treatment on carbon black so that a phosphorus-containing group is bonded (grafted) to the surface of carbon black. Examples of such a physical treatment include a vacuum plasma treatment. Further, examples of the chemical treatment include an oxidation treatment using hypohalous acid and/or a hypohalite, an oxidation treatment using ozone, and an oxidation treatment using persulfuric acid and/or a persulfate.

In addition, examples of the self-dispersing pigment other than carbon black include a pigment obtained by bonding a phosphorus-containing group to the surface of the pigment via a phenyl group. Various known surface treatment methods can be applied as a surface treatment method for bonding, and examples of such a surface treatment method include a method of bonding a phosphorus-containing group to the surface of the pigment via a phenyl group by bonding sulfanilic acid, p-aminobenzoic acid, 4-aminosalicylic acid, or the like to the surface of the pigment. Further, the above-described functional group introduced to the surface of the pigment may be formed into a salt.

The content of the self-dispersing pigment A (solid content) is preferably 1.0% by mass or greater and 6.0% by mass or less, more preferably 1.5% by mass or greater and 5.0% by mass or less, and still more preferably 1.8% by mass or greater and 4.5% by mass or less with respect to the total mass of the ink jet ink composition. When the content of the self-dispersing pigment A is in the above-described ranges, the color developability and the clogging recovering properties may be more excellent.

The volume average particle diameter D50 of the self-dispersing pigment A is 150 nm or less. The volume average particle diameter D50 of the self-dispersing pigment A is preferably 50 nm or greater and 150 nm or less, more preferably 70 nm or greater and 150 nm or less, and still more preferably 80 nm or greater and 120 nm or less. When the volume average particle diameter D50 thereof is in the above-described ranges, sedimentation and aggregation of the pigment in an ink tank or the like are likely to be suppressed. Further, when the volume average particle diameter D50 of the self-dispersing pigment A is 70 nm or greater, an image with more satisfactory color developability can be formed.

The volume average particle diameter D50 of the self-dispersing pigment can be measured using, for example, MICROTRAC MT-3300 (manufactured by MicrotracBEL Corp., laser diffraction/scattering type particle size distribution measuring device).

### 1.2. Self-Dispersing Pigment B

The ink jet ink composition according to the present embodiment contains the self-dispersing pigment B having a volume average particle diameter D50 of 90 nm or greater and 150 nm or less and containing a functional group other than a phosphorus-containing group.

The self-dispersing pigment B reacts with calcium when a recording medium contains calcium, and thus an image with excellent color developability is likely to be formed. More excellent color developability is obtained by an interaction between the self-dispersing pigment A and the self-dispersing pigment B in a case of the self-dispersing pigment B having a surface to which a carboxyl group, a sulfo group, or the like other than the phosphorus-containing group such as a phosphoric acid group or a phosphonic acid group is bonded.

A pigment obtained by bonding a hydrophilic group other than the phosphorus-containing group to the surface of the pigment directly or via other atomic groups is used as the self-dispersing pigment B, and examples thereof include a pigment obtained by bonding a functional group containing an anionic group other than the phosphorus-containing group to the surface of the pigment particles and a pigment obtained by chemically bonding an anionic resin containing a hydrophilic group other than the phosphorus-containing group to the surface of the pigment particles.

Examples of the hydrophilic group contained in the surface of the self-dispersing pigment B include —OM, —COOM, —CO—, —SO₃M, —SO₂M, —SO₂NH₂, —RSO₂M, —SO₂NHCOR, —NH₃, —NR₃, and a group in which some hydrogen atoms of a propyleneoxy chain have been substituted with M. In the formulae, M represents a hydrogen atom, an alkali metal, ammonium, or an organic amine, and R represents an alkyl group having 1 or more and 12 or less carbon atoms or a naphthyl group which may have a substituent.

Further, examples of the other atomic groups include a linear or branched alkylene group having 1 or more and 12 or less carbon atoms, a phenylene group, a naphthylene group, an amide group, a sulfonyl group, an amino group, a carbonyl group, an ester group, an ether group, and a group obtained by combining these groups.

Examples of the self-dispersing pigment B include a pigment obtained by bonding an anionic group other than a phosphorus-containing group to the surface of the pigment particles by performing an oxidation treatment using a known method and a pigment obtained by bonding a functional group containing an anionic group other than a phosphorus-containing group to the surface of the pigment particles by performing diazo coupling, and both pigments can be suitably used. The self-dispersing pigment obtained by bonding an anionic resin to the surface of the pigment particles is a pigment in which a resin having a unit containing at least an anionic group other than a phosphorus-containing group as a hydrophilic unit is bonded to the surface of the pigment particles directly or via other atomic groups.

The pigment of a self-dispersing type is not particularly limited, and the description thereof is the same as in the section of the self-dispersing pigment A described above.

The above-described pigment can be defined as the self-dispersing pigment B obtained by bonding an anionic group other than a phosphorus-containing group to the surface of the particles directly or via other atomic groups.

For example, when carbon black is used as the self-dispersing pigment B, the self-dispersing pigment B is produced by, for example, performing a physical treatment or a chemical treatment on carbon black so that a hydrophilic group other than a phosphorus-containing group is bonded (grafted) to the surface of carbon black. Examples of such a physical treatment include a vacuum plasma treatment. Further, examples of the chemical treatment include an oxidation treatment using hypohalous acid and/or a hypohalite, an oxidation treatment using ozone, and an oxidation treatment using persulfuric acid and/or a persulfate.

Further, a commercially available product can be used as carbon black used as the self-dispersing pigment B, and examples thereof include CAB-O-JET (registered trademark) 300 (manufactured by Cabot Specialty Chemicals Inc.).

Meanwhile, examples of the self-dispersing pigment B other than carbon black include a pigment obtained by bonding a hydrophilic group to the surface of the pigment via a phenyl group. Various known surface treatment methods can be applied as a surface treatment method of bonding the above-described functional group as a hydrophilic group other than a phosphorus-containing group or a salt thereof to the surface of the pigment via a phenyl group, and examples of such a surface treatment method include a method of bonding a hydrophilic group to the surface of the pigment via a phenyl group by bonding sulfanilic acid, p-aminobenzoic acid, 4-aminosalicylic acid, or the like to the surface of the pigment.

A commercially available product can also be used as such a color pigment used as the self-dispersing pigment B, and examples thereof include CAB-O-JET (registered trademark) 250C, CAB-O-JET (registered trademark) 260M, and CAB-O-JET (registered trademark) 470Y (all manufactured by Cabot Specialty Chemicals Inc.).

The content of the self-dispersing pigment B (solid content) is preferably 1.0% by mass or greater and 6.0% by mass or less, more preferably 1.5% by mass or greater and 5.0% by mass or less, and still more preferably 1.8% by mass or greater and 4.5% by mass or less with respect to the total mass of the ink jet ink composition. When the content of the self-dispersing pigment B is in the above-described ranges, the color developability and the clogging recovering properties may be more excellent. Further, the above-described functional group introduced to the surface of the pigment may be formed into a salt.

The volume average particle diameter D50 of the self-dispersing pigment B is 90 nm or greater and 150 nm or less. The volume average particle diameter D50 of the self-dispersing pigment B is preferably 90 nm or greater and 120 nm or less, more preferably 90 nm or greater and 110 nm or less, and still more preferably 95 nm or greater and 105 nm or less. When the volume average particle diameter D50 thereof is in the above-described ranges, sedimentation and aggregation of the pigment in an ink tank or the like are likely to be suppressed.

### 1.3. Relationship Between Self-Dispersing Pigment a and Self-Dispersing Pigment B

A mass ratio (A/B) of the content of the self-dispersing pigment A to the content of the self-dispersing pigment B is preferably 0.1 or greater and 3.0 or less, more preferably 0.3 or greater and 2.5 or less, still more preferably 0.4 or greater and 2.3 or less, and even still more preferably 0.6 or greater and 2.0 or less. In this manner, an image with more satisfactory color developability can be formed.

Further, the total content of the self-dispersing pigment A and the self-dispersing pigment B is preferably 2% by mass or greater and 10% by mass or less, more preferably 4% by mass or greater and 8% by mass or less, and still more preferably 5% by mass or greater and 7% by mass or less with respect to the total mass of the ink jet ink composition. In this manner, sedimentation and aggregation of the pigment in an ink tank or the like can be further suppressed, and an image with more excellent color developability can be obtained.

Further, it is more preferable that the volume average particle diameter D50 of the self-dispersing pigment A be greater than the volume average particle diameter D50 of the self-dispersing pigment B. In this manner, sedimentation of the pigment can be further suppressed. The hydrophobicity of the self-dispersing pigment B is relatively higher than that of the self-dispersing pigment A. Therefore, it is assumed that the particles of the self-dispersing pigment B are likely to be collected in water, likely to be sedimented, and difficult to redisperse. Accordingly, it is preferable that the self-dispersing pigment B have a volume average particle diameter D50 less than that of the self-dispersing pigment A so that the particles of the self-dispersing pigment B are difficult to sediment. The volume average particle diameter D50 of the self-dispersing pigment A is greater than the volume average particle diameter D50 of the self-dispersing pigment B by more preferably 5 nm or greater and still more preferably 10 nm or greater and 60 nm or less.

### 1.4. Other Components

The ink jet ink composition of the present embodiment may contain the following components.

### 1.4.1. Water

The ink jet ink composition according to the present embodiment is an aqueous composition containing water. The term “aqueous” composition is a composition containing water as one of the main solvents. Examples of water include pure water such as ion exchange water, ultrafiltration water, reverse osmosis water, or distilled water, and ultrapure water which are obtained by reducing ionic impurities. Further, in a case where water sterilized by irradiation with ultraviolet rays, addition of hydrogen peroxide, or the like is used, generation of bacteria or fungi can be suppressed when the ink jet ink composition is stored for a long time.

The content of water is 30% by mass or greater, preferably 40% by mass or greater, more preferably 45% by mass or greater, and still more preferably 50% by mass or greater with respect to the total amount (100% by mass) of the ink jet ink composition. Further, the upper limit of the content of water is preferably 978 by mass or less, more preferably 90% by mass or less, still more preferably 85% by mass or less, and even still more preferably 80% by mass or less with respect to the total amount (100% by mass) of the ink composition.

### 1.4.2. Betaine

The ink jet ink composition according to the present embodiment may contain betaines. The betaine is a compound in which positive and negative charges are present at non-adjacent positions in the same molecule and no dissociable hydrogen is bonded to the atom having the positive charges and which can constitute intramolecular salts and does not have charges as the entire molecule. In the present embodiment, it is preferable that a positively charged moiety of the betaine be a quaternary ammonium cation.

When the ink jet ink composition contains the betaine, flight deflection and jetting failure of the ink jet ink composition caused by the ink jet ink composition being dried in a nozzle of an ink jet head can be suppressed, and the clogging resistance can be improved.

The above-described self-dispersing pigment A is a hydrophilic substance, and the dispersibility thereof is decreased in some cases in a liquid environment that has become hydrophobic due to evaporation of water, as in an environment of a clogging recovery test. Particularly, in the ink jet ink composition of the present embodiment, it is considered that since the above-described self-dispersing pigment A and the above-described self-dispersing pigment B coexist, the self-dispersing pigment A is likely to be a nucleus of foreign matter, and the self-dispersing pigment B is likely to be formed into foreign matter by being mixed into the nucleus. However, when the ink jet ink composition of the present embodiment contains betaines, such a phenomenon is unlikely to occur, which is preferable.

The betaines are not particularly limited, and examples thereof include trialkylglycine such as trimethylglycine or triethylglycine, γ-butyrobetaine, homarine, trigonelline, carnitine, homoserine betaine, valine betaine, lysine betaine, ornithine betaine, alanine betaine, stachydrine, and glutamic acid betaine. Among these, it is preferable that the glycine contained in the ink jet ink composition be selected from trialkylglycine and more preferable that the ink jet ink composition contain trimethylglycine. The trialkylglycine is a compound in which the nitrogen atom of glycine has been substituted with three alkyl groups. In this manner, the clogging resistance tends to be further improved. Further, the betaine may be used alone or in combination of two or more kinds thereof.

The number of carbon atoms constituting the betaine is preferably 4 or more and 12 or less, more preferably 4 or more and 7 or less, and still more preferably 4 or more and 6 or less. When the number of carbon atoms in the betaine is in the above-described ranges, sedimentation of the pigment tends to be more significantly suppressed.

When the ink jet ink composition contains betaines, the content thereof is preferably 2.0% by mass or greater and 10.0% by mass or less, more preferably 3.0% by mass or greater and 9.0% by mass or less, and still more preferably 4.0% by mass or greater and 8.0% by mass or less with respect to the total mass of the ink jet ink composition. When the content of the betaines is in the above-described ranges, sedimentation of the pigment and the formation of the pigment into foreign matter can be further suppressed, and the clogging recovering properties can be further enhanced.

### 1.4.3. Organic Solvent

The ink jet ink composition according to the present embodiment may contain the following organic solvents. Examples of the organic solvents include alkyl polyol, glycol ether, and nitrogen-containing compounds.

### Alkyl Polyol

The ink jet ink composition according to the present embodiment may contain alkyl polyol. The alkyl polyol is a compound having a skeleton portion and containing two or more hydroxyl groups (substituted with two or more hydroxyl groups). Examples of the skeleton portion include an alkyl chain and a polyalkyleneoxy chain. The number of hydroxyl groups in a molecule is 2 or more, preferably in a range of 2 to 4, and more preferably 2 or 3. The number of carbon atoms in a molecule is preferably in a range of 2 to 10.

The concept of alkyl polyol includes polyhydric alcohol, but in a case where the ink jet ink composition contains alkyl polyol, the moisture retaining properties of the ink jet ink composition are enhanced, and the moisture evaporation from a recording head when the head is allowed to stand for a long time can be effectively suppressed while the jetting stability using an ink jet method is improved. Further, in this manner, even when a coloring material of a type that is likely to cause clogging of a nozzle is used, the recovering properties after standing and the continuous jetting stability can be more satisfactorily maintained.

Specific examples of the alkyl polyol include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, diethylene glycol, propylene glycol, dipropylene glycol, glycerin, triethylene glycol, and tetraethylene glycol. These alkyl polyols may be used alone or in combination of two or more kinds thereof.

Among the alkyl polyols, it is more preferable that the ink jet ink composition contain alkanediol having 3 or more and 6 or less carbon atoms. Examples of the alkanediol having 3 or more and 6 or less carbon atoms include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-1,3-propanediol, 2,2-dimethyl-1,3-propanediol, 3-methyl-1,3-butanediol, 3-methyl-1,5-pentanediol, and 2-methylpentane-2,4-diol.

When the ink jet ink composition contains the alkanediol having 3 or more and 6 or less carbon atoms, an increase in viscosity is further suppressed, and the jetting stability (continuous jetting reliability) can be more satisfactorily increased. Further, the solubility and the dispersibility of the coloring material are likely to be enhanced, and satisfactory clogging recovering properties can be obtained.

When the ink jet ink composition contains the alkyl polyol, it is more preferable that the ink jet ink composition contain polyols having a standard boiling point of higher than 280° C. Examples of the polyols having a standard boiling point of higher than 280° C. include glycerin and triethylene glycol. When the ink jet ink composition contains such polyols, an increase in drying speed of the ink jet ink composition can be suppressed, and the clogging resistance and the jetting stability can be further enhanced. The content of the alkyl polyol is preferably in a range of 2% to 30% by mass, more preferably in a range of 5% to 20% by mass, and still more preferably in a range of 8% to 15% by mass with respect to the total amount of the ink jet ink composition.

### Glycol Ether

The ink jet ink composition according to the present embodiment may contain glycol ether. Examples of the glycol ether include monoalkyl ether and dialkyl ether of glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. More specific examples thereof include methyl triglycol (triethylene glycol monomethyl ether), butyl triglycol (triethylene glycol monobutyl ether), butyl diglycol (diethylene glycol monobutyl ether), and dipropylene glycol monopropyl ether, and typical examples thereof include diethylene glycol monobutyl ether.

Among the glycol ethers, it is still more preferable that the ink jet ink composition contain one or more kinds selected from glycol ether represented by Formula (1).

R¹—O—(CH₂—CH₂—O)ₙ—R² (1)

(In Formula (1), R¹ represents H or an alkyl group having 1 or more and 4 or less carbon atoms, R² represents an alkyl group having 1 or more and 4 or less carbon atoms, and n represents an integer of 2 or greater and 3 or less.)

Examples of the glycol ether represented by Formula (1) include methyl triglycol (triethylene glycol monomethyl ether), butyl triglycol (triethylene glycol monobutyl ether), butyl diglycol (diethylene glycol monobutyl ether), triethylene glycol dimethyl ether, triethylene glycol dibutyl ether, and diethylene glycol dibutyl ether.

The glycol ether may be used in the form of a mixture of a plurality of kinds thereof. When glycol ether is used, from the viewpoint of adjusting the viscosity of the ink jet ink composition and suppressing clogging due to the moisture retaining effect, the amount of the glycol ether to be blended is 0.5% by mass or greater and 30% by mass or less, preferably 1.0% by mass or greater and 20% by mass or less, and more preferably 3.0% by mass or greater and 10.0% by mass or less with respect to the total amount of the ink jet ink composition.

### Nitrogen-Containing Compounds

The ink jet ink composition according to the present embodiment may contain nitrogen-containing compounds. For example, amides are preferable as the nitrogen-containing compounds. Examples of the amides include a cyclic amide and an acyclic amide. The nitrogen-containing compounds can be expected to have an effect of suppressing the ink jet ink composition from being solidified or dried.

Examples of the cyclic amide include a compound having a ring structure that contains an amide group. Examples of such a compound include γ-lactams such as 2-pyrrolidone, 1-methyl-2-pyrrolidone (N-methyl-2-pyrrolidone), 1-ethyl-2-pyrrolidone (N-ethyl-2-pyrrolidone), 1-propyl-2-pyrrolidone, 1-butyl-2-pyrrolidone, and N-vinyl-2-pyrrolidone (NVP), β-lactams, δ-lactams, and ε-lactams such as ε-caprolactam. These cyclic amides may be used alone or in combination of two or more kinds thereof.

### Other Organic Solvents

The ink jet ink composition according to the present embodiment may contain other organic solvents. Examples of the other organic solvents include lactones such as γ-butyrolactone and a betaine compound.

The content of the organic solvent is preferably in a range of 2% to 30% by mass, more preferably in a range of 5% to 20% by mass, and still more preferably in a range of 8% to 15% by mass with respect to the total amount of the ink jet ink composition.

### 1.4.4. Resin Particles

The ink jet ink composition may contain resin particles. In the present specification, the resin particles will also be referred to as a dispersion resin. Since the resin particles are likely to cause degradation of the clogging resistance, the content of the resin particles when the ink jet ink composition contains the resin particles is preferably 1% by mass or less, more preferably 0.5% by mass or less, still more preferably 0.3% by mass or less, even still more preferably 0.1% by mass or less, and particularly preferably less than 0.1% by mass with respect to the total mass of the ink jet ink composition. For the same reason as described above, it is more preferable that the ink jet ink composition contain no resin particles.

When the ink contains resin particles, the ink is easily foamed and thus air bubbles are likely to be formed due to the surfactant (dispersant) for dispersing the resin. Air bubbles are likely to be formed particularly when the ink storage container is filled with the ink from the ink filling hole.

Further, the resin particles are likely to be formed into foreign matter at the gas-liquid interface inside the ink storage container. Further, when air bubbles are formed, the number of gas-liquid interfaces is increased, and thus foreign matter is likely to be formed at the gas-liquid interfaces.

Further, since the resin particles are not soluble in water, there are concerns of environmental problems due to microplastics when the ink flows out to the natural environment. Examples of the resin dispersion include a dispersion resin dispersed by a surfactant and a soap-free dispersion resin dispersed without using a surfactant.

### 1.4.5. Surfactant

The ink jet ink composition according to the present embodiment may contain a surfactant. The surfactant can be used for reducing the surface tension of the ink jet ink composition to adjust and improve the wettability with respect to a recording medium and the permeability into, for example, fabrics. As the surfactant, any of a nonionic surfactant, an anionic surfactant, a cationic surfactant, or an amphoteric surfactant can be used, and these surfactants may be used in combination. Further, among the surfactants, an acetylene glycol-based surfactant, a silicone-based surfactant, and a fluorine-based surfactant can be more preferably used.

The acetylene glycol-based surfactant is not particularly limited, and examples thereof include SURFYNOL 104, 104E, 104H, 104A, 104BC, 104DPM, 104PA, 104PG-50, A104S, 420, 440, 465, 485, SE, SE-F, 504, 61, DF37, CT111, CT121, CT131, CT136, TG, GA, and DF110D (all trade names, manufactured by Air Products and Chemicals Inc.), OLFINE B, Y, P, A, STG, SPC, E1004, E1010, PD-001, PD-002W, PD-003, PD-004, PD-005, EXP. 4001, EXP. 4036, EXP. 4051, EXP. 4123, EXP. 4200, EXP. 4300, D-10PG, AF-103, AF-104, AK-02, SK-14, and AE-3 (all trade names, manufactured by Nissin Chemical Co., Ltd.), and ACETYLENOL E00, EOOP, E40, and E100 (all trade names, manufactured by Kawaken Fine Chemicals Co., Ltd.).

The silicone-based surfactant is not particularly limited, and preferred examples thereof include a polysiloxane-based compound. The polysiloxane-based compound is not particularly limited, and examples thereof include polyether-modified organosiloxane. Examples of a commercially available product of the polyether-modified organosiloxane include BYK-306, BYK-307, BYK-333, BYK-341, BYK-345, BYK-346, and BYK-348 (all trade names, manufactured by BYK-Chemie Japan K.K.), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemical Co., Ltd.).

As the fluorine-based surfactant, a fluorine-modified polymer is preferably used, and examples thereof include BYK-340 (trade name, manufactured by BYK-Chemie Japan K.K.).

When the surfactant is blended into the ink jet ink composition, the total content of the surfactant is 0.01% by mass or greater and 3% by mass or less, preferably 0.05% by mass or greater and 2% by mass or less, more preferably 0.1% by mass or greater and 1.5% by mass or less, and particularly preferably 0.2% by mass or greater and 1% by mass or less with respect to the total amount of the ink jet ink composition.

When the surfactant is blended into the ink jet ink composition, it is more preferable to select a surfactant having defoaming properties. Air bubbles are unlikely to be formed by allowing the ink jet ink composition to contain a surfactant having defoaming properties, and for example, the stability when the ink is jetted from a head tends to increase.

### 1.4.6. Chelating Agent

The ink jet ink composition according to the present embodiment may use a chelating agent. The chelating agent is capable of removing predetermined ions from the ink jet ink composition.

Examples of the chelating agent include ethylenediaminetetraacetic acid and salts thereof such as EDTA, ethylenediaminetetraacetic acid disodium salt dehydrate (EDTA-2Na), ethylenediaminetetraacetic acid trisodium salt monohydrate (EDTA-3Na), ethylenediaminetetraacetic acid tetrasodium salt (EDTA-4Na), and ethylenediaminetetraacetic acid tripotassium salt monohydrate (EDTA-3K), diethylenetriaminepentaacetic acid and salts thereof such as DTPA, diethylenetriaminepentaacetic acid disodium salt (DTPA-2Na) and diethylenetriaminepentaacetic acid pentasodium salt (DTPA-5Na), nitrilotriacetic acid and salts thereof such as NTA, nitrilotriacetic acid disodium salt (NTA-2Na) and nitrilotriacetic acid trisodium salt (NTA-3Na), ethylenediamine-N, N′-disuccinic acid and salts thereof, 3-hydroxy-2,2′-iminodisuccinic acid and salts thereof, L-aspartic acid-N,N′-diacetic acid and salts thereof, L-glutamic acid diacetic acid and salts thereof, N-(1-carboxylatomethyl)iminodiacetic acid and salts thereof, and N-(2-hydroxyethyl)iminodiacetic acid and salts thereof.

Further, examples of the chelating agent other than acetic acid analogues include ethylenediaminetetramethylenephosphonic acid and salts thereof, ethylenediaminetetrametaphosphoric acid and salts thereof, ethylenediaminepyrophosphoric acid and salts thereof, and ethylenediaminemetaphosphoric acid and salts thereof.

When the ink jet ink composition according to the present embodiment contains the chelating agent, one or two or more kinds selected from the above-described examples can be used.

### 1.4.7. pH Adjuster

A pH adjuster can be added to the ink jet ink composition according to the present embodiment. The pH adjuster is not particularly limited, and examples thereof include appropriate combinations of acids, bases, weak acids, and weak bases. As the acids and the bases used in such combinations, examples of inorganic acids include sulfuric acid, hydrochloric acid, and nitric acid, examples of inorganic bases include lithium hydroxide, sodium hydroxide, potassium hydroxide, potassium dihydrogen phosphate, disodium hydrogen phosphate, potassium carbonate, sodium carbonate, sodium hydrogen carbonate, and ammonia, examples of organic bases include triethanolamine, tripropanolamine, diethanolamine, monoethanolamine, triisopropanolamine, diisopropanolamine, and trishydroxymethylaminomethane (THAM), and examples of organic acids include adipic acid, citric acid, succinic acid, lactic acid, good buffers such as N, N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), morpholinopropanesulfonic acid (MOPS), carbamoylmethyliminobisacetic acid (ADA), piperazine-1,4-bis(2-ethanesulfonic acid) (PIPES), N-(2-acetamido)-2-aminoethanesulfonic acid (ACES), cholamine chloride, N-tris(hydroxymethyl)methyl-2-aminoethanesulfonic acid (TES), acetamidoglycine, tricine, glycinamide, and bicine, a phosphate buffer solution, a citrate buffer solution, and a tris buffer solution. Further, among these, the ink jet ink composition contains a tertiary amine such as triethanolamine or triisopropanolamine, and a carboxyl group-containing organic acid such as adipic acid, citric acid, succinic acid, or lactic acid as a part or the entirety of the pH adjuster, which is preferable from the viewpoint of more stably obtaining a pH buffering effect.

### 1.4.8. Ureas

As a moisturizing agent of the ink jet ink composition, ureas may be used as a dyeing assistant that improves dyeing properties of a dye. Specific examples of the ureas include urea, ethylene urea, tetramethyl urea, thiourea, and 1,3-dimethyl-2-imidazolidinone. When the ink jet ink composition contains ureas, the content thereof can be set to 1% by mass or greater and 10% by mass or less with respect to the total mass of the ink jet ink composition.

### 1.4.9. Preservative, Fungicide, and Rust Inhibitor

The ink jet ink composition may use a preservative and a fungicide. Examples of the preservative and the fungicide include sodium benzoate, sodium pentachlorophenol, sodium 2-pyridinethiol-1-oxide, sodium sorbate, sodium dehydroacetate, 1,2-dibenzoisothiazolin-3-one (PROXEL CRL, PROXEL BDN, PROXEL GXL, PROXEL XL-2, PROXEL TN, and PROXEL LV, manufactured by Zeneca Inc.), and 4-chloro-3-methylphenol (PREVENTOL CMK and the like, manufactured by Bayer AG). Examples of the rust inhibitor include benzotriazole.

### 1.4.10. Saccharides

The ink jet ink composition may contain saccharides. Specific examples of the saccharides include glucose, mannose, fructose, ribose, xylose, arabinose, galactose, aldonic acid, glucitol (sorbitol), maltose, cellobiose, lactose, sucrose, trehalose, and maltotriose.

### 1.4.11. Other Components

The ink jet ink composition may further contain, as other components in addition to the above-described components, additives that can be typically used in an ink jet ink composition for ink jet, such as an antioxidant, an ultraviolet absorbing agent, an oxygen absorbing agent, and a dissolution assistant.

### 1.5. Applications and the Like

The ink jet ink composition according to the present embodiment may be used by an ink jet recording device including an ink storage container that has an ink filling hole. Hereinafter, the ink jet recording device including an ink storage container that has an ink filling hole will be described.

The ink jet recording device is an ink jet recording device that includes the above-described ink jet ink composition, an ink storage container in which the ink jet ink composition is stored, and a recording head jetting the ink jet ink composition, and the ink storage container has an ink filling hole used to be filled with the ink jet ink composition and configured to be opened and closed. The ink jet recording device includes the above-described ink jet ink composition.

The ink jet recording device includes the above-described ink jet ink composition, an ink storage container in which the ink jet ink composition is stored, and a recording head jetting the ink jet ink composition, and the ink storage container has an ink filling hole used to be filled with the ink jet ink composition and configured to be opened and closed.

An example of the ink jet recording device according to the present embodiment will be described with reference to the accompanying drawings. Further, the ink storage container is an ink tank of an ink jet type printer (ink jet recording device) that performs recording (printing) of an image or the like on a medium by jetting an ink to the medium. Further, in the description below, the ink jet recording device will also be simply referred to as a recording device, and the ink jet ink composition will also be simply referred to as an ink.

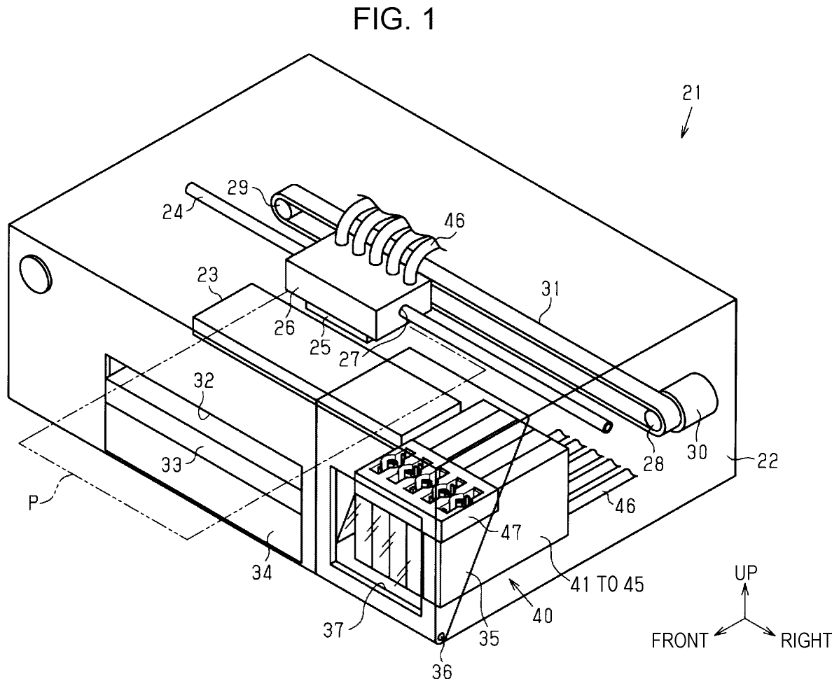

As shown in FIG. 1, a recording device 21 includes a rectangular parallelepiped housing 22 in which the left-right direction thereof is set as the longitudinal direction. Further, FIG. 1 schematically shows the inside of the housing 22 in the recording device 21 in a see-through state. A support stand 23 in which the left-right direction is set as the longitudinal direction is provided in a rear lower portion of the housing 22 such that the upper surface thereof is disposed in a substantially horizontal direction. Paper P as an example of a medium is transported forward which is a transport direction while being supported by the upper surface of the support stand 23. A guide shaft 24 extending in the left-right direction is provided at the upper position of the support stand 23 inside the housing 22, and a carriage 26 that includes, on a lower surface side thereof, a recording head 25 (ink jet head) jetting the ink is supported by the guide shaft 24. That is, the carriage 26 is reciprocatably supported by the guide shaft 24 in the left-right direction in a state where the guide shaft 24 is inserted into a support hole 27 penetrating through the carriage 26 in the left-right direction.

Further, a drive pulley 28 and a driven pulley 29 are rotatably supported at positions in the vicinity of both ends of the guide shaft 24 inside the housing 22. An output shaft of a carriage motor 30 is connected to the drive pulley 28, and an endless timing belt 31 that is partially connected to the carriage 26 is wound between the drive pulley 28 and the driven pulley 29. Further, when the carriage 26 reciprocates due to the driving of the carriage motor 30 in the left-right direction which is the scanning direction on the paper P while being guided by the guide shaft 24 through the timing belt 31, the ink is jetted to the paper P transported forward on the support table 23 from the recording head 25 disposed on the lower surface side of the carriage 26.

Further, the recording device may be a serial type recording device that performs recording by allowing a recording head to jet the ink while a carriage included in the recording head moves as shown in FIG. 1. Alternatively, the recording head may be a line type recording head that performs recording by allowing a recording head that is a line head having a length greater than or equal to a recording width of a recording medium to jet the ink.

Further, as shown in FIG. 1, a rectangular discharge port 32 that discharges, to the front side, the paper P on which recording has been performed by allowing the recording head 25 to jet the ink when the paper P is transported on the support stand 23 inside the housing 22 is opened at a position which is the front side of the support stand 23 on the front surface side of the housing 22. The discharge port 32 is provided with a rectangular plate-like discharge tray 33 configured to support the paper P discharged from the housing 22 such that the discharge tray 33 is projectable to and retractable from the front side in the discharge direction. Further, a paper feed cassette 34 configured to store a plurality of sheets of paper P used for recording an image in a laminated state is attached onto the lower side of the discharge tray 33 in the discharge port 32 such that the paper feed cassette 34 is freely inserted and removed in a front and rear direction.

Further, as shown in FIG. 1, an opening/closing door 35 having rectangular front and upper surfaces and a right-angled triangular right side surface is provided at a position which is the front surface of the housing 22 and on an end portion side (a right end portion side in FIG. 1) of the discharge port 32 in the left-right direction such that the opening/closing door 35 is freely opened and closed in the front and rear direction using, as the center of rotation, the rotation shaft 36 provided at the lower end of the opening/closing door 35 in the left-right direction. A window portion 37 formed of a rectangular transparent member is formed at the front surface of the opening/closing door 35 such that a user can visually recognize the inside of the housing 22 (particularly, the rear side of the front surface of the opening/closing door 35) in a state where the opening/closing door 35 is closed.

An ink supply unit 40 that supplies the ink to the recording head 25 is stored at a position which is a rear side of the opening/closing door 35, that is, a position closer to the front surface and closer to an end portion (in this case, closer to a right end portion) inside the housing 22 of the recording device 21. The ink supply unit 40 is a structure including a plurality (five in the present embodiment) of ink storage containers 41 to 45 and configured to be integrally handled, and each of the ink storage containers 41 to 45 can be replenished with the ink as described above.

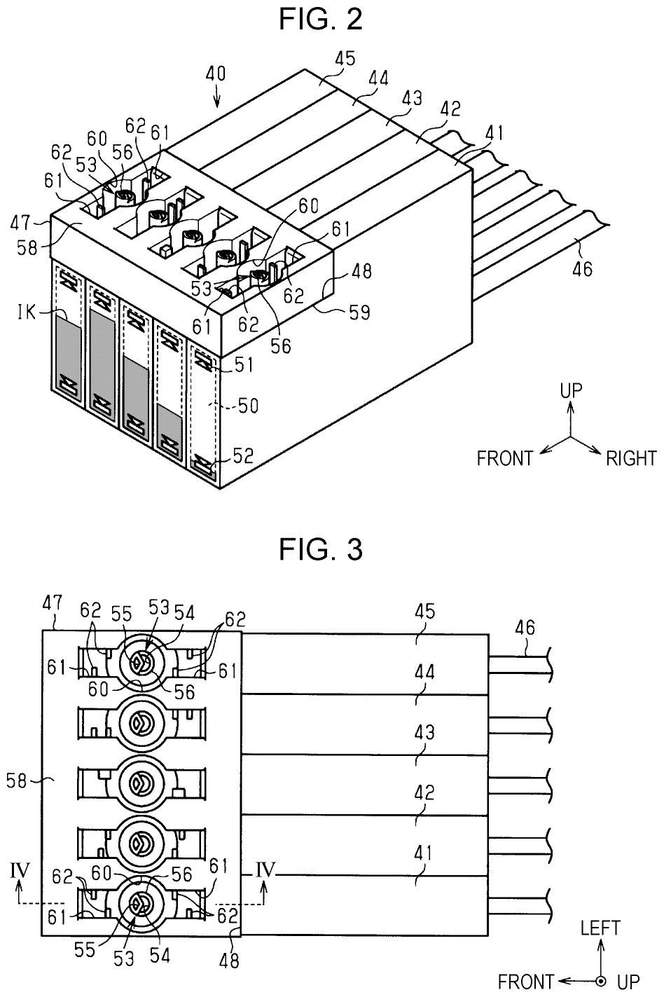

As shown in FIGS. 2 and 3, the ink supply unit 40 includes five modified box-shaped ink storage containers 41 to 45 which are long in the front and rear direction, five ink supply pipes 46 pulled from the rear surface side of each of the ink storage containers 41 to 45, and a rectangular parallelepiped adapter 47 for ink replenishment which is assembled with a collection of the ink storage containers 41 and 45. The adapter 47 for ink replenishment is integrated with the ink storage containers 41 to 45 by being assembled with a stepped portion 48 formed in a notch in an upper front half portion of all the ink storage containers 41 to 45 in a state where all the ink storage containers 41 to 45 are arranged side by side by setting the width direction as the left-right direction. Further, as shown in FIG. 1, the ink supply pipes 46 pulled out from the ink storage containers 41 to 45 are coupled to an ink flow passage (not shown) formed in the carriage 26 and coupled to the recording head 25 through this ink flow passage. Further, the adapter 47 for ink replenishment may constitute a part of the housing 22 covering the ink storage containers 41 to 45 or may be formed integrally with the ink storage containers 41 to 45.

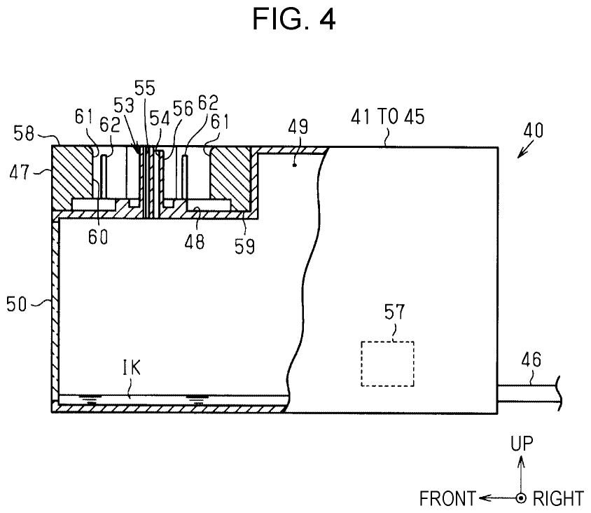

As shown in FIG. 4, the ink storage containers 41 to 45 each have an ink storage chamber 49 configured to store an ink composition IK inside thereof. In a case of the present embodiment, a black ink is stored in the ink storage chamber 49 of the ink storage container 41 positioned at the right end in the lateral direction. Further, an ink of a color (cyan, magenta, yellow, or the like) other than black is stored in the ink storage chamber 49 of each of the ink storage containers 42 to 45 arranged on a left side of the ink storage container 41 positioned at the right end in the lateral direction. Further, a viewing portion 50 formed of a transparent resin that enables visual recognition of the liquid level of the ink composition IK inside the ink storage chamber 49 is provided on a front wall portion that is visually recognizable through the window portion 37 on the front surface of the housing 22 in the ink storage container 41 to 45. In addition, an upper limit mark 51 indicating the standard of the upper limit of the liquid level of the ink composition IK stored in the ink storage chamber 49 (example of a standard amount of the ink that can be poured without overflowing from an ink inlet 53) and a lower limit mark 52 indicating the standard of the lower limit thereof (for example, a standard to prompt ink replenishment) are provided in the viewing portion 50.

As shown in FIG. 4, the ink inlet 53 (ink filling hole) configured to be opened and closed and to enable inflow of the ink from the outside to the inside of the ink storage chamber 49 is provided on the upper side of a horizontal portion of the stepped portion 48 in the ink storage containers 41 to 45. The ink inlet 53 is formed to include a needle 56 having flow passages 54 and 55 that make the inside and outside of the ink storage chamber 49 communicate with each other and extending in the vertical direction. The flow passages 54 and 55 of the needle 56 are two flow passages 54 and 55 disposed side by side in a radiation direction in which each of tip openings is centered on the needle 56, and one flow passage 54 (right side in FIG. 4) of these two flow passages 54 and 55 has a tip opening with a height less than that of the other flow passage 55 (left side in FIG. 4), and the flow passage thereof is formed to have a large cross-sectional area. Further, a remaining amount sensor 57 for detecting the remaining amount of the ink composition IK inside the ink storage chamber 49 is provided in a lower portion close to a rear side in the ink storage chamber 49. Further, the remaining amount sensor 57 may not be provided.

As shown in FIGS. 2 to 4, an upper surface 58 of the adapter 47 for ink replenishment is a horizontal surface in a direction orthogonal (intersecting) to a direction in which the needle 56 extends, and a through-hole 60 penetrating from a lower surface 59 in the vertical direction is formed at the upper surface 58 thereof as an ink inlet forming portion. This through-hole 60 is formed of the ink inlet 53 having a circular hole shape in which the needle 56 is disposed at the center thereof and a pair of front and rear rectangular holes at the front and rear side of the ink inlet 53, which are connected to each other, and an opening on the lower side thereof is blocked by the horizontal portion of the stepped portion 48 in which the needle 56 protrudes upward in the ink storage containers 41 to 45.

Therefore, a pair of front and rear recesses 61 that are open upwardly in a direction in which the needle 56 extends are formed to be recessed in a point-symmetrical manner with respect to the ink inlet 53 by defining the vertically downward direction as the depth direction using a pair of front and rear rectangular holes with a blocked lower opening, in a region outside the ink inlet 53 in a radiation direction centering on the ink inlet 53 in the through-hole 60. That is, a plurality (a pair of two recesses which are front and rear recesses in this case) of recesses 61 are formed in a point-symmetrical manner with respect to the ink inlet 53 in a region outside the ink inlet 53 including the needle 56 in the adapter 47 for ink replenishment that is integrated with the ink storage containers 41 to 45. Further, in this case, the tip of the needle 56 disposed at the center of the ink inlet 53 having a circular hole shape is positioned on a side of the ink storage chamber 49 with respect to the upper surface 58 of the adapter 47 for ink replenishment, which is an opening edge of the through-hole 60 including the ink inlet 53 and the recess 61. That is, the upper surface 58 of the adapter 47 for ink replenishment extends in a direction intersecting the direction in which the needle 56 extends at a position outside the tip of the needle 56 in the direction in which the needle 56 extends. Meanwhile, the lower surface 59 of the adapter 47 for ink replenishment functions as a tank engaging portion that is engaged with a collection of the plurality of ink storage containers 41 to 45 arranged side by side in the left-right direction from the upper side.

Further, a peripheral portion of the opening edge on the upper side of each through-hole 60 on the upper surface 58 of the adapter 47 for ink replenishment is colored in a specific color. That is, the peripheral portion is colored in the same color as the color of the ink stored in the ink storage chamber 49 of the ink storage containers 41 to 45 into which the ink flows through the ink inlet 53 of the through-hole 60. From this viewpoint, the peripheral portion of the opening edge on the upper side of each through-hole 60 in the adapter 47 for ink replenishment functions as a first portion showing, to the outside, information related to the ink stored inside the ink storage containers 41 to 45 communicating with the ink inlet 53 of the through-hole 60 and the ink storage chamber 49. In addition, the ink stored in the ink storage containers 41 to 45 is not particularly limited, but when the ink storage container storing and supplying the ink composition according to the present embodiment is defined as the ink storage container 41, the ink storage container 41 stores a black ink or a gray ink, and thus the peripheral portion of the upper opening of the through-hole 60 in which the ink inlet 53 communicating with the ink storage chamber 49 of the ink storage container 41 is disposed is colored in black or gray.

Further, a first uneven portion (first key structure portion) 62 having a characteristic uneven shape in the horizontal direction is provided to extend in a depth direction (that is, a direction of the central axis of the ink inlet 53) of the recess 61, at a position on a bottom surface side (that is, a horizontal portion side of the stepped portion 48) with respect to the opening edge on the upper side of the recess 61 on the inner surface (specifically, the inside surface in the vertical direction) of the recess 61. As shown in FIGS. 2 and 3, the first uneven portion 62 is provided for each ink inlet 53 of the plurality (five in the present embodiment) of ink storage containers 41 to 45. Therefore, in the adapter 47 for ink replenishment, a first uneven portion 62 different from a first uneven portion 62 provided on the inner surface of the recess 61 of another through-hole 60 is formed for each through-hole 60 in the rectangular recess 61 in each through-hole 60 formed at a position corresponding to each of the ink storage containers 41 to 45 in the vertical direction. That is, these first uneven portions 62 function as an identification unit configured to identify an ink bottle 63 having an ink outlet 65 coupled to the ink inlet 53 inside the through-hole 60 in which each first uneven portion 62 is formed. Further, the expression of “position on a bottom surface side with respect to the opening edge on the upper side of the recess 61” denotes a position that can be slightly retreated to the bottom surface side with respect to the opening edge.

Next, the ink bottle 63 will be described as an ink replenishment container that constitutes an ink replenishment system together with the ink storage containers 41 to 45 and replenishes the ink to the ink storage containers 41 to 45 when the remaining amount of the ink is low. The above-described ink jet ink composition is stored in the ink bottle 63.

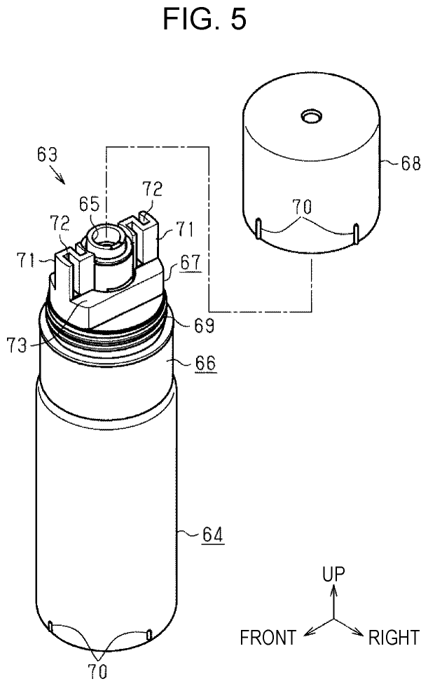

As shown in FIG. 5, the ink bottle 63 includes a cylindrical container main body portion 64 serving as a main component of the ink bottle 63, an ink outlet forming portion 66 which is provided at a tip portion of the container main body portion 64 and in which the ink outlet 65 configured to allow the ink to flow out from the inside of the ink bottle 63 has a tip at which an opening is formed, and a container addition portion 67 added to the ink outlet forming unit 66 to surround the ink outlet 65. The ink outlet 65 of the ink outlet forming unit 66 and the container addition portion 67 in the periphery of the ink outlet 65 are covered with a bottomed cylindrical cap 68 and thus are hidden from the outside when the ink bottle 63 is stored. That is, a female thread portion (not shown) is formed at the inner peripheral surface of the cap 68 while a male thread 69 is formed at the outer peripheral surface of the cylindrical lower end portion of the container addition portion 67, the female thread portion of the cap 68 is screwed to the male thread portion 69 of the container addition portion 67 so that the cap 68 is attached to the tip portion of the ink bottle 63 to cover the ink outlet 65.

Further, the entire outer surface of the container addition portion 67 is colored in a specific color. That is, the container addition portion 67 is colored in the same color as the color of the ink stored in the container main body portion 64 to which the container addition portion 67 is added. In addition, the outer surface of the container addition portion 67 in the ink bottle 63 storing a black or gray ink is colored in black or gray. Further, a plurality (four in the present embodiment) of protrusions 70 are formed at equal angular intervals (for example, at intervals of 90 degrees) on the outer peripheral surface of each base end portion of the container main body portion 64 and the cap 68. In addition, these protrusions 70 are formed to prevent the cylindrical ink bottle 63 from rolling. Further, for example, the container main body portion 64 of the ink bottle 63 storing a black color may be formed to be thicker than the container main body portions 64 of the ink bottles 63 storing inks of other colors. In this case, the ink outlet forming portion 66 for a black ink may be formed to have the same thickness and the same shape as those for inks of other colors.

The material of the container main body portion 64 is not limited, and plastics, metals, glass, or the like can be used. Among these, from the viewpoint of being lightweight, plastics are preferable. Among the plastics, soft plastic is preferable. The soft plastic is plastic that can be dent when both sides of the container main body portion 64 are pinched by hand. The container main body portion 64 formed of soft plastic is preferable from the viewpoint that the ink is likely to be pushed out from the ink outlet 65 by turning the container main body portion 64 upside down and pinching both sides of the container main body portion 64 between fingers so that the container main body portion 64 is dented.

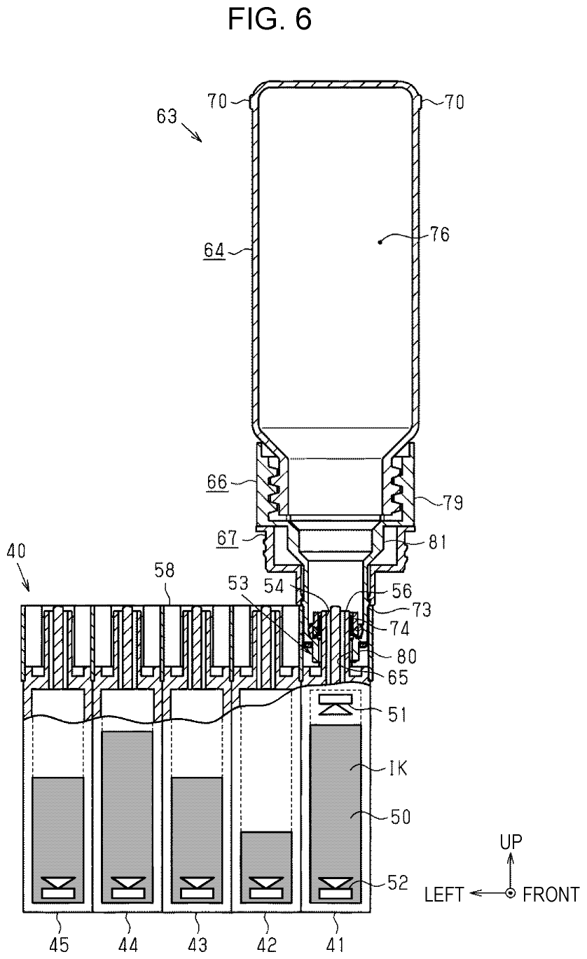

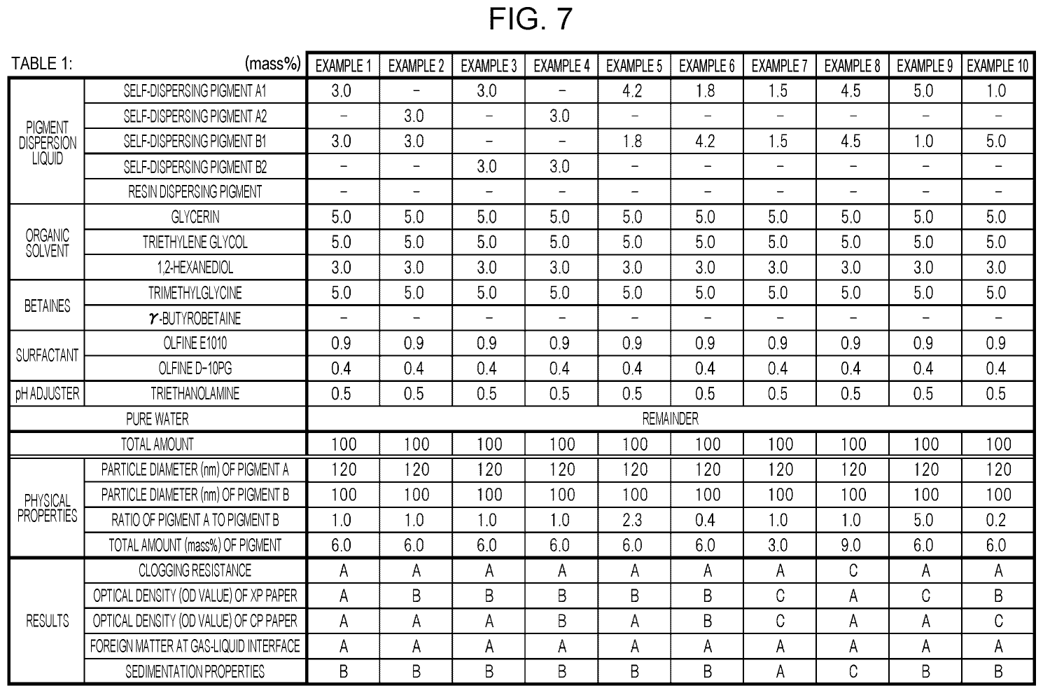

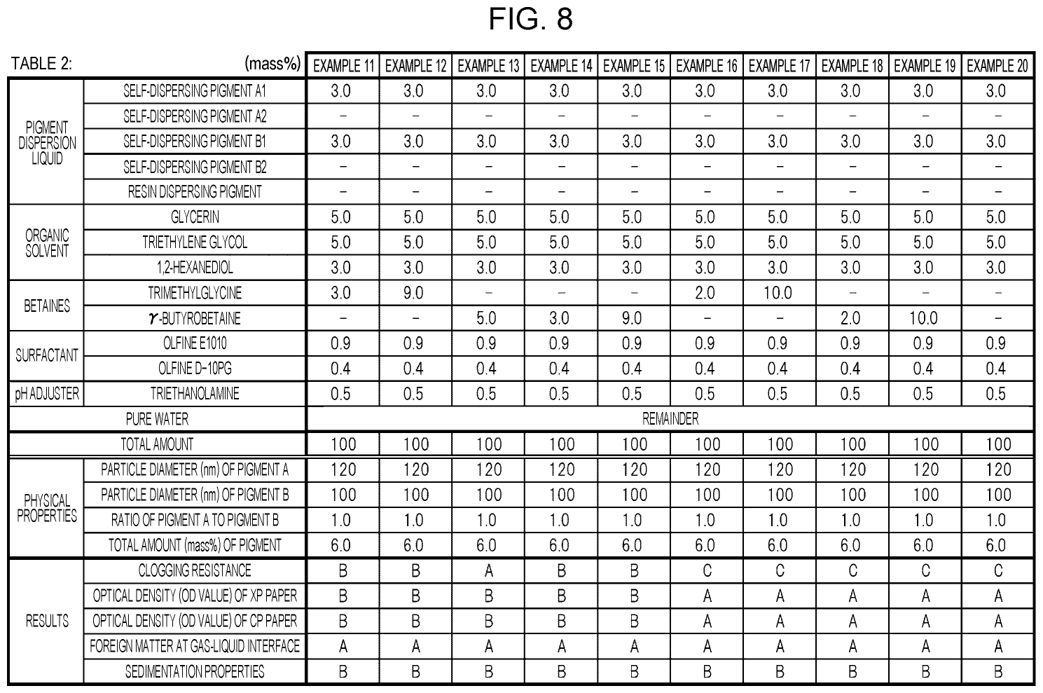

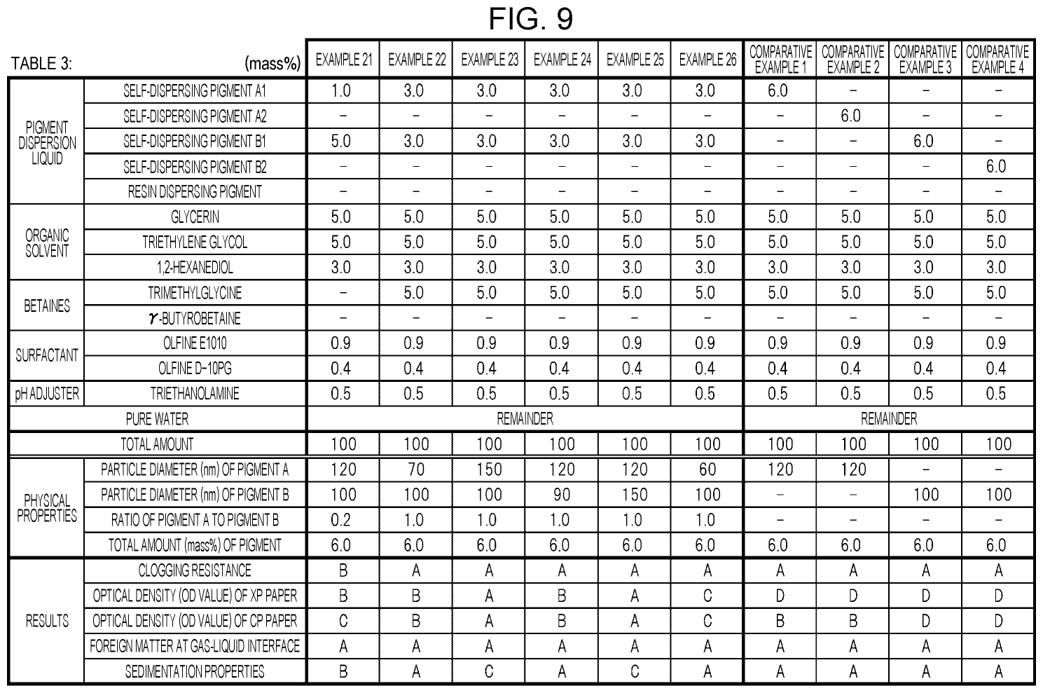

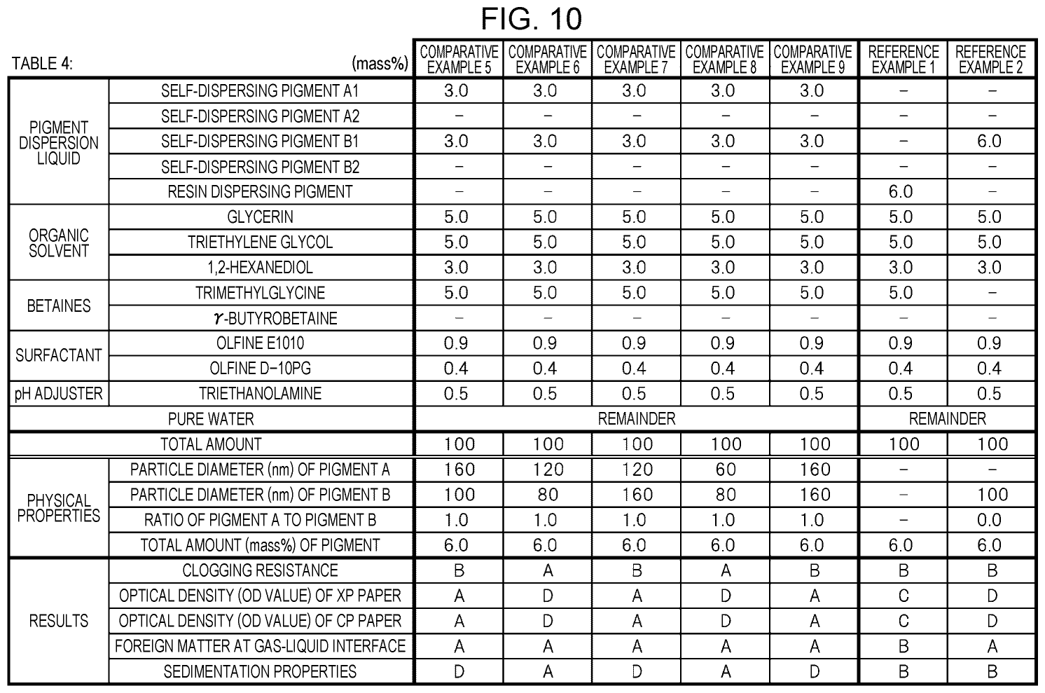

As shown in FIG. 6, the user holds the ink bottle 63 such that the ink outlet 65 is positioned above the through-hole 60 on the rightmost side in the adapter 47 for ink replenishment by turning the ink bottle 63 storing the ink composition used for ink replenishment upside down. That is, the central axis line of the ink outlet 65 of the ink bottle 63 is aligned with the central axis line of the ink inlet 53 of the ink storage container 41 to which the ink is replenished. Here, the user visually compares the color (second portion) used to color the container addition portion 67 of the ink bottle 63 held by hand with the color (first portion) used to color the periphery of the opening edge on the upper side of the through-hole 60 where the ink inlet 53 of the ink storage container 41 to which the ink is replenished is provided. Further, when the colors are the same as each other (in this case, black), it is confirmed that the ink bottle 63 suitable for the current ink replenishment is held by hand, and the ink replenishment is carried out. That is, the ink is replenished from the ink bottle to the ink storage container.

As shown in FIG. 6, it is preferable that the ink bottle 63 be positioned above the ink inlet 53 of the ink storage container 41 by turning the ink bottle 63 upside down when the ink is replenished from the viewpoint of easily replenishing the ink. Further, the position of the ink bottle 63 during the replenishment of the ink is not limited to the position above the ink inlet 53, and the ink bottle 63 may be positioned obliquely above the ink inlet 53.

Further, as shown in FIG. 6, it is preferable that the ink be replenished in a state where the ink outlet 65 of the ink bottle 63 is in contact with the vicinity of the ink inlet 53 of the ink storage container 41 from the viewpoint that the ink is difficult to spill. Further, since the position of the ink bottle 63 is fixed to the vicinity of the ink inlet 53 of the ink storage container 41, the container main body portion 64 of the ink bottle 63 is likely to be dent, and thus the ink is likely to be pushed out and replenished.

In these cases, since the ink is likely to be pushed out from the ink outlet 65 of the ink bottle 63, the ink is likely to be foamed, air bubbles are likely to be formed, and foreign matter is likely to be generated at the gas-liquid interface, but the present embodiment is preferable from the viewpoint of reducing formation of air bubbles and foreign matter.

In FIG. 2 and the like, the ink inlet 53 may be covered with a lid, a cap, or the like (not shown) when the ink is not replenished. That is, the ink inlet 53 may be configured to be opened or closed with a lid or a cap.

According to the ink jet recording device described above, sedimentation of the pigment in the ink storage container (ink tank) can be suppressed when the above-described ink jet ink composition is applied. Further, it is clear that the ink jet ink composition of the present embodiment can suppress sedimentation of the pigment in the flow passage of the ink and in the ink cartridge even when the ink jet ink composition is applied to a recording device that does not include an ink tank.

### 1.6. Production and Physical Properties

The ink jet ink composition according to the present embodiment can be obtained by mixing the above-described components in any order, filtering the mixture as necessary, and removing impurities. As a mixing method, a method of sequentially adding materials to a container provided with a stirring device such as a mechanical stirrer or a magnetic stirrer and stirring and mixing the materials is suitably used. For example, centrifugal filtration or filter filtration can be performed as necessary as a filtration method.

From the viewpoint of the reliability of an ink jet ink, the surface tension of the ink jet ink composition according to the present embodiment at 20° C. is preferably 20 mN/m or greater and 40 mN/m or less and more preferably 22 mN/m or greater and 35 mN/m or less. Further, from the same viewpoint as described above, the viscosity of the ink at 20° C. is preferably 1.5 mPa·s or greater and 10 mPa·s or less and more preferably 2 mPa·s or greater and 8 mPa·s or less. The surface tension and the viscosity of the ink may be set to be in the above-described ranges by a method of adjusting the kinds of the water-soluble resin, the organic solvent, and the surfactant described above, the amounts of these components and water to be added, and the like.

### 1.7. Effects and the Like

According to the ink jet ink composition of the present embodiment, since the ink jet ink composition is formed of a pigment having a volume average particle diameter D50 of 150 nm or less, sedimentation and aggregation of the pigment in an ink tank can be suppressed. Further, since the ink jet ink composition is formed of two kinds of pigments subjected to two different kinds of surface treatments, the pigments are likely to remain on the surface of a recording medium, and accordingly, an image with excellent color developability can be obtained.

In a recording medium (recording medium with high reactivity) rich in cations, such as so-called colorlok paper, the pigment (self-dispersing pigment A) with relatively high cation reactivity reacts with the cations and remains on the surface of the recording medium, and thus the print density can be improved. However, the self-dispersing pigment A contains a phosphorus-containing group (such as phosphonic acid) and thus the hydrophilicity is high. Therefore, the ink having landed on the recording medium is difficult to separate from a solvent component of the ink, which is mainly formed of water, and thus the filling effect is weak.

In a recording medium (recording medium with low reactivity) having a small amount of cations, such as so-called non-colorlok paper, the print density (color developability) can be improved by combining the above-described self-dispersing pigment A and the self-dispersing pigment B (pigment with relatively low cation reactivity).

The self-dispersing pigment B contain a functional group (a carboxyl group, a sulfo group, or the like) other than a phosphorus-containing group and has hydrophobicity higher than that of the pigment A, and accordingly, the ink having landed on the recording medium quickly undergoes solid-liquid separation from the solvent component of the ink, which is mainly formed of water, and voids of the recording medium are filled with the self-dispersing pigment B (filling effect). In this manner, the self-dispersing pigment A remains on the recording medium in a state where the voids are filled, and thus the color developability is excellent. In this manner, the print density can be improved.

It is considered that the voids of the recording medium are roughly filled with the self-dispersing pigment B, the self-dispersing pigment A is densely spread thereon, and as a result, the color developability is enhanced.

It is considered that since pigments subjected to two different kinds of surface treatments are used, the surface of the recording medium is initially filled with the self-dispersing pigment B, and the self-dispersing pigment A is likely to remain thereon. Such an effect is considered to be generated due to some kind of interaction such as repulsion or affinity between the pigments by using the pigments subjected to two different kinds of surface treatments.

In a case where a recording medium with low reactivity, the filling effect is considered to be obtained by setting the volume average particle diameter D50 of the self-dispersing pigment B to 90 nm or greater. Meanwhile, the lower limit of the volume average particle diameter D50 of the self-dispersing pigment A is not limited, but as the effect of spreading the self-dispersing pigment A on the self-dispersing pigment B to increase the color developability, the color developability is considered to be more excellent as the particle diameter of the self-dispersing pigment A increases.

The sedimentation properties are considered to be affected mainly by the volume average particle diameters D50 of the self-dispersing pigment A and the self-dispersing pigment B. Further, since both the self-dispersing pigment A and the self-dispersing pigment B coexist, these pigments are mixed with each other and thus more likely to be sedimented.

### 2. Recording Method

A recording method according to the present embodiment includes a step of jetting the above-described ink jet ink composition from an ink jet head to make the ink jet ink composition adhere to a recording medium. The recording method according to the present embodiment may be performed by using the ink jet recording device that includes the ink storage container having an ink filling hole as described above. Further, the recording method includes a step of jetting the above-described ink jet ink composition from an ink jet head of the ink jet recording device to make the ink jet ink composition adhere to a recording medium.

According to the ink jet recording method, the ink jet ink composition contains a self-dispersing pigment, a water-soluble resin, and a betaine, and when the content of the self-dispersing pigment is 3.5% by mass or greater and 8.5% by mass or less with respect to the total mass of the ink composition, the mass ratio (self-dispersing pigment/water-soluble resin) of the self-dispersing pigment to the water-soluble resin is 2.8 or greater and less than 30, and the content of the betaine is 2.5% by mass or greater and 9.5% by mass or less with respect to the total mass of the ink composition, foaming of the ink jet ink composition and generation of foreign matter are suppressed, and an image having satisfactory color developability and satisfactory rub fastness can be formed.

The recording medium is not particularly limited, and the recording medium may or may not have a recording surface that absorbs a liquid. Therefore, the recording medium is not particularly limited, and for example, paper, a film, cloth, a metal, glass, or a polymer can be used. Further, transfer paper for performing sublimation transfer to a recording medium can also be used as the recording medium.

A liquid-absorbing recording medium is more preferable as the recording medium on which recording is performed by the recording method according to the present embodiment. The liquid-absorbing recording medium denotes “recording medium in which the water absorption amount from the start of contact to 30 msec^{1/2} in the Bristow method is greater than 10 mL/m²”. The Bristow method is a method that has been most widely used as a method of measuring the liquid absorption amount in a short time and that is also adopted by Japan Technical Association of The Pulp And Paper Industry (JAPAN TAPPI). The details of the recording method are described in Standard No. 51 “Paper and Paperboard, Liquid Absorbency Test Method, Bristow Method” of “Paper and Pulp Test Method (2000) by JAPAN TAPPI”.

As the liquid-absorbing recording medium, a recording medium having liquid absorbency due to a receiving layer provided to absorb a liquid on the surface of the recording medium may be used. Examples thereof include ink jet paper (paper exclusively for ink jet). Examples of the receiving layer that absorbs a liquid include a layer formed of a liquid-absorbing resin, liquid-absorbing inorganic fine particles, or the like.

Examples of the liquid-absorbing recording medium include a recording medium in which the base material of the recording medium has liquid absorbency. Examples thereof include fabrics formed of fibers and paper containing pulp as a component. Examples of the paper include plain paper, cardboard, and liner paper. Examples of the liner paper include paper formed of kraft pulp or used paper.

Plain paper is particularly preferable. Examples of the plain paper include high-quality paper and recycled paper. Among the examples of the plain paper, plain paper with a relatively high cation content and plain paper with a relatively low cation content may also be considered. The plain paper with a relatively high cation content is more likely to react with the pigment and have enhanced color developability due to the reaction with the pigment as compared with the plain paper with a relatively low cation content.

In a case where the ink according to the present embodiment is used, excellent color developability is obtained even when plain paper with a relatively low cation content is used, and excellent color developability is obtained even when any of the above-described plain papers is used, which is preferable. Examples of the cation include a calcium salt. The calcium salt is capable of generating a calcium ion which is a cation when the ink adheres to the calcium salt.

According to the recording method of the present embodiment, recording may be performed on an absorbing recording medium, and the pigment is likely to be retained on the surface of the recording medium even when the recording medium is an absorbing recording medium, and an image with satisfactory color developability can be obtained.

The step of making the ink jet ink composition adhere to the recording medium can be performed by using the above-described ink jet recording device. That is, the step of making the ink jet ink composition adhere to the recording medium can be performed by filling the ink jet head with the ink jet ink composition such that the ink jet ink composition can be jetted from a predetermined nozzle and jetting the ink jet ink composition to the recording medium at a predetermined timing in the above-described state.

Further, the recording method according to the present embodiment may include a step of heating the recording medium as appropriate. The step of heating the recording medium can be performed by, for example, using the above-described drying method or the like when the ink jet recording device is used. Further, the recording medium can be heated by an appropriate drying method without limiting to the ink jet recording device. In this manner, an image to be obtained can be dried, bleeding of the image can be suppressed, and the image can be more efficiently fixed. In addition, the recording method may include a step of replenishing the ink to the ink storage container.

Further, other steps can be added to the recording method according to the present embodiment as appropriate, and the recording method may include, for example, a step of applying other compositions and a washing step. According to the recording method of the present embodiment, since the above-described ink jet ink composition is used, foaming of the ink jet ink composition and generation of foreign matter can be suppressed, and an image with a satisfactory image quality and satisfactory fastness can be formed.

According to the recording method of the present embodiment, since the ink jet ink composition containing a pigment with a volume average particle diameter D50 of 150 nm or less is used, sedimentation and aggregation of the pigment in an ink tank can be suppressed. Further, according to the recording method, since the ink jet ink composition is formed of two kinds of pigments subjected to two different kinds of surface treatments, the pigments are likely to be retained on the surface of a recording medium, and accordingly, an image with excellent color developability can be obtained.

### 3. Examples and Comparative Examples

Hereinafter, the present disclosure will be described in detail based on examples, but the present disclosure is not limited to these examples. Hereinafter, “parts” and “%” are on a mass basis unless otherwise specified. The mass percentage of the pigment in the tables is the mass percentage of the solid content in the pigment. Further, the evaluation was performed in an environment of a temperature of 25.0° C. and a relative humidity of 40.0% unless otherwise specified.

### 3.1. Preparation of Ink Jet Ink Composition

Ink jet ink compositions of the examples, the comparative examples, and reference examples were obtained by adding respective components to a container to have the compositions listed in Tables 1 to 4, mixing and stirring the mixtures with a magnetic stirrer for 2 hours, and filtering the mixtures through a membrane filter having a pore size of 5 μm. As the pigment, the pigment dispersion liquid prepared as described below was used.

The substances other than those listed by the compound names in Tables 1 to 4 are as follows.
A self-dispersing pigment A1 was produced in the following manner.

20.0 g of a pigment, 11.0 mmol of monosodium salt of ((4-aminobenzoylamino)-methane-1,1-diyl)bisphosphate, 20.0 mmol of nitric acid, and 200 mL of pure water were mixed with each other.

Carbon black (trade name “BLACK PEARLS 880”, manufactured by Cabot Corporation) was used as the pigment. Further, the mixture was mixed at 6,000 rpm using a Silverson mixer at room temperature. After 30 minutes, 20.0 mmol of sodium nitrite dissolved in a small amount of water was slowly added to this mixture.

The temperature of the mixture reached 60° C. by adding sodium nitrite. The mixture was allowed to react in this state for 1 hour. Thereafter, the mixture was washed with water, and the pH of the mixture was adjusted to 10 by using a sodium hydroxide aqueous solution.

The obtained pigment was a self-dispersing pigment in which a —C₆H₄—CONH—CH—(PO(OH)(ONa))(PO(OH)₂) group was bonded to the surface of particles of the pigment.
A self-dispersing pigment A2 was produced in the following manner.

A self-dispersing pigment to which a benzenephosphonic acid group was bonded was obtained by performing the same operation as described above except that the phosphonic acid source of the self-dispersing pigment A1 was changed to 4-aminobenzylphosphonic acid.
A self-dispersing pigment B1 was produced in the following manner.

A classification operation was performed on CAB-O-JET (manufactured by Cabot Corporation, carboxylate-treated self-dispersing pigment), thereby obtaining a pigment dispersion liquid with a required particle diameter.
A self-dispersing pigment B2 was produced in the following manner.

1.96 g of p-aminobenzenesulfonic acid was added to a solution obtained by dissolving 5 g of concentrated hydrochloric acid in 5.5 g of water in a state where the solution was cooled to 5° C. Next, a container containing this solution was placed in an ice bath and the solution was stirred so that the solution was constantly in a state of being maintained at 10° C. or lower, and a solution obtained by dissolving 2.2 g of potassium nitrite in 9 g of water at 5° C. was added to the solution. The solution was further stirred for 15 minutes, and 6 g (solid content) of carbon black (with a specific surface area of 220 m²/g and a DBP oil absorption amount of 105 mL/100 g) was added thereto while the solution was stirred. Thereafter, the solution was further stirred for 15 minutes. The obtained slurry was filtered through filter paper (trade name, “Standard Filter Paper No. 2”, manufactured by ADVANTEC CO., LTD.), and the particles were sufficiently cooled with water and dried in an oven at 110° C. Thereafter, potassium ions were substituted with ammonium ions by an ion exchange method, and the content of the pigment was adjusted to 10.0% to obtain a dispersion liquid. Thereafter, a classification operation was performed, thereby obtaining a pigment dispersion liquid with a required particle diameter. In this manner, a self-dispersing pigment B2 in a state where the self-dispersing pigment in which a benzenesulfonic acid group having ammonium as a counter ion was bonded to the surface of the pigment particles was dispersed in water was obtained.
A resin dispersing pigment was produced in the following manner.

20 parts by mass of an organic solvent (methyl ethyl ketone), 0.03 parts by mass of a polymerization chain transfer agent (2-mercaptoethanol), 15 parts by mass of polypropylene glycol monomethacrylate (propylene oxide group=9), 15 parts by mass of poly(ethylene glycol/propylene glycol) monomethacrylate (propylene oxide group=7, ethylene oxide group=5), 12 parts by mass of methacrylic acid, 50 parts by mass of a styrene monomer, 10 parts by mass of a styrene macromer, and 10 parts by mass of benzyl methacrylate were added to a reaction container sufficiently subjected to nitrogen gas substitution, the mixture was stirred at 75° C., and 0.9 parts by mass of 2,2′-azobis(2,4-dimethylvaleronitrile) serving as a polymerization initiator which was dissolved in 40 parts by mass of methyl ethyl ketone with respect to 100 parts by mass of monomer components was added to the mixture for polymerization, thereby obtaining a polymer solution aged at 80° C. for 1 hour.

7.5 parts by mass of the water-soluble polymer obtained above was dissolved in 45 parts by mass of methyl ethyl ketone, a predetermined amount of a 20% sodium hydroxide aqueous solution (neutralizing agent) was added to the solution to neutralize a salt-forming group, 20 parts by mass of carbon black (trade name “BLACK PEARLS 880”, manufactured by Cabot Corporation) was further added to the solution as a pigment, and the solution was kneaded using a bead mill for 2 hours. 120 parts by mass of ion exchange water was added to the kneaded material obtained in the above-described manner, the solution was stirred, methyl ethyl ketone was removed at 6° C. under reduced pressure, and a part of water was further removed from the solution, thereby obtaining a resin-coated pigment dispersion liquid having a solid content concentration of 20% by mass.

Further, each pigment dispersing liquid was prepared and subjected to a classification treatment, thereby obtaining a dispersion liquid of the pigment having a volume average particle diameter D50 for each example. The classification treatment was performed by using a centrifuge.
OLFINE E1010: manufactured by Nissin Chemical Co., Ltd., acetylene glycol-based surfactant
OLFINE D-10PG: manufactured by Nissin Chemical Co., Ltd., acetylene glycol-based surfactant

### 3.2. Evaluation Method

### 3.2.1. Recording Test

PX-M886FL (manufactured by Seiko Epson Corporation) was modified and prepared by installing an ink storage container having an ink filling hole. The ink storage container as shown in the figure was prepared.

XeroxP (manufactured by Fuji Xerox Co., Ltd.) was used as a recording medium used for performing recording of a recording test. A monochrome 100% Duty pattern was recorded by setting the amount of the ink to adhere to the recording medium to 4 mg/inch².

### 3.2.2. Clogging Resistance

The head of the recording device was filled with the ink of each example, the recording test was performed, and the head was allowed to stand in an environment of 40° and 20% RH for 7 days in a state where the head was not covered with a cap, and the head was cleaned. The clogging recovering properties were determined according to the following criteria based on the number of times of cleaning, and the results are listed in Tables 1 to 4. The rank of B or higher is desirable.
A: Clogging was recovered within 6 times of cleaning.
B: Clogging was recovered with 7 times of cleaning.
C: Clogging was not recovered with 7 times of cleaning.

### 3.2.3. Optical Density

The monochrome 100% Duty pattern in which the amount of the ink to adhere to the recording medium was 4 mg/inch² was printed in an environment of 20° C. and 50% RH and measured by a colorimeter. The evaluation was performed according to the following criteria based on the obtained OD values. The evaluation results are listed in Tables 1 to 4.

As the recording medium, Copy Plus paper (CP paper, manufactured by HAMMERMILL Paper Company) was used in addition to XP paper (XeroxP paper).

CP paper is plain paper with a relatively high cation content, and XP paper is plain paper with a relatively low cation content. Further, since CP paper is a recording medium that is required to have high color developability, the evaluation criteria are different from those for XP paper.

The rank of C or higher is desirable, and the rank of B or higher is preferable in both cases.

### Optical Density (OD Value) of XP Paper

When the printing was performed on XeroxP paper (XP paper) (recording medium with low reactivity), the results were as follows.
A: The OD value was 1.2 or greater.
B: The OD value was 1.15 or greater and less than 1.2.
C: The OD value was 1.1 or greater and less than 1.15.
D: The OD value was less than 1.1.

### Optical Density (OD Value) of CP Paper

When the printing was performed on Copy Plus paper (CP paper) (recording medium with high reactivity), the results were as follows.
A: The OD value was 1.3 or greater.
B: The OD value was 1.2 or greater and less than 1.3.
C: The OD value was 1.15 or greater and less than 1.2.
D: The OD value was less than 1.15.

### 3.2.4. Foreign Matter at Gas-Liquid Interface

About 30 g of the ink was poured into a 50 mL screw tube and allowed to stand in an environment of 60° C. for 5 days in a state where the screw tube was covered with a cap. It was determined whether or not foreign matter was generated, and the results are listed in Tables 1 to 4. The rank of A is desirable.
A: Foreign matter was not generated.
B: Foreign matter was generated.

### 3.2.5. Sedimentation Properties

An ink storage container of a recording tester was filled with 50 mL of the ink, the ink was allowed to be naturally sedimented (stand) for 2 weeks, and printing was performed. The same pattern as in the optical density test was recorded by arraying the pattern over the entire surface of one sheet of a recording medium (XP paper). Among the patterns, a color difference (ΔE value) between the lightest pattern and the darkest pattern was confirmed. Further, the color difference is ΔE of the CIE Lab color system. The colors were measured by using a spectrophotometer (model: Spectrolino, manufactured by GretagMacbeth LLC) with a D65 light source. The results are listed in Tables 1 to 4. The rank of C or higher is desirable, and the rank of B or higher is preferable.
A: ΔE<1.0
B: 1.0≤ΔE<2.0
C: 2.0≤ΔE<2.5
D: 2.5≤ΔE

### 3.3. Evaluation Results

As listed in Tables 1 to 4, it was found that the ink jet ink composition of each example, which contained the pigment formed of the self-dispersing pigment A having a volume average particle diameter D50 of 150 nm or less and containing a phosphorus-containing group and the self-dispersing pigment B having a volume average particle diameter D50 of 90 nm or greater and 150 nm or less and containing a functional group other than a phosphorus-containing group, exhibited satisfactory color developability of an image and satisfactorily suppressed sedimentation of the pigments.

The present disclosure has configurations that are substantially the same as the configurations described in the embodiments, for example, configurations with the same functions, the same methods, and the same results as described above or configurations with the same purposes and the same effects as described above. Further, the present disclosure has configurations in which parts that are not essential in the configurations described in the embodiments have been substituted. Further, the present disclosure has configurations exhibiting the same effects as the effects of the configurations described in the embodiments or configurations capable of achieving the same purposes as the purposes of the configurations described in the embodiments. Further, the present disclosure has configurations in which known techniques have been added to the configurations described in the embodiments.

The following contents are derived from the embodiments and the modified examples described above.

An ink jet ink composition includes a pigment formed of a self-dispersing pigment A having a volume average particle diameter D50 of 150 nm or less and containing a phosphorus-containing group and a self-dispersing pigment B having a volume average particle diameter D50 of 90 nm or greater and 150 nm or less and containing a functional group other than the phosphorus-containing group.

According to the ink jet ink composition, since the ink jet ink composition is formed of the pigment having a volume average particle diameter D50 of 150 nm or less, sedimentation and aggregation of the pigment in an ink tank can be suppressed. Further, since the ink jet ink composition is formed of two kinds of pigments subjected to two different kinds of surface treatments, the pigments are likely to remain on the surface of a recording medium, and accordingly, an image with excellent color developability can be obtained.

In the ink jet ink composition, an ink jet recording device that includes an ink tank having an ink filling hole may be used.

According to this ink jet ink composition, even when the recording device includes an ink tank having an ink filling hole, sedimentation of the pigment in the ink tank can be suppressed.

In the ink jet ink composition, the self-dispersing pigment A may have a volume average particle diameter D50 of 70 nm or greater and 150 nm or less.

According to this ink jet ink composition, since the self-dispersing pigment A has a volume average particle diameter D50 of 70 nm or greater, an image with more satisfactory color developability can be formed.

In the ink jet ink composition, a mass ratio (A/B) of the self-dispersing pigment A to the self-dispersing pigment B may be 0.4 or greater and 2.5 or less.

According to this ink jet ink composition, an image with more satisfactory color developability can be formed.

In the ink jet ink composition, a total content of the self-dispersing pigment A and the self-dispersing pigment B may be 4% by mass or greater and 8% by mass or less with respect to a total mass of the ink jet ink composition.

According to this ink jet ink composition, sedimentation and aggregation of the pigment in the ink tank can be further suppressed, and an image with more excellent color developability can be obtained.

In the ink jet ink composition, the ink jet ink composition may contain betaines.

According to this ink jet ink composition, clogging recovering properties can be further enhanced.

In the ink jet ink composition, a content of the betaines may be 3% by mass or greater and 10% by mass or less with respect to the total mass of the ink jet ink composition.

According to this ink jet ink composition, the clogging recovering properties can be further enhanced.

In the ink jet ink composition, the volume average particle diameter D50 of the self-dispersing pigment A may be greater than the volume average particle diameter D50 of the self-dispersing pigment B.

According to this ink jet ink composition, sedimentation of the pigments can be further suppressed.

In the ink jet ink composition, the ink jet ink composition may be used for recording on an absorbing recording medium.

According to this ink jet ink composition, the pigments are likely to be retained on the surface of the recording medium even when the recording medium is an absorbing recording medium, and an image with satisfactory color developability can be obtained.

A recording method includes a step of jetting any of the above-described ink jet ink compositions from an ink jet head to make the ink jet ink composition adhere to a recording medium.

According to the recording method of the present embodiment, since the ink jet ink composition containing a pigment with a volume average particle diameter D50 of 150 nm or less is used, sedimentation and aggregation of the pigment in an ink tank can be suppressed. Further, according to the recording method, since the ink jet ink composition is formed of two kinds of pigments subjected to two different kinds of surface treatments, the pigments are likely to be retained on the surface of a recording medium, and accordingly, an image with excellent color developability can be obtained.

What is claimed is:

1. An ink jet ink composition being an aqueous composition comprising:
a pigment formed of a self-dispersing pigment A having a volume average particle diameter D50 of 150 nm or less and containing a phosphorus-containing group, and a self-dispersing pigment B having a volume average particle diameter D50 of 90 nm or greater and 150 nm or less and containing a functional group other than the phosphorus-containing group.

2. The ink jet ink composition according to claim 1,
wherein the ink jet ink composition is used for an ink jet recording device that includes an ink tank having an ink filling hole.

3. The ink jet ink composition according to claim 1,
wherein the self-dispersing pigment A has a volume average particle diameter D50 of 70 nm or greater and 150 nm or less.

4. The ink jet ink composition according to claim 1,
wherein a mass ratio (A/B) of the self-dispersing pigment A to the self-dispersing pigment B is 0.4 or greater and 2.5 or less.

5. The ink jet ink composition according to claim 1,
wherein a total content of the self-dispersing pigment A and the self-dispersing pigment B is 4% by mass or greater and 8% by mass or less with respect to a total mass of the ink jet ink composition.

6. The ink jet ink composition according to claim 1, further comprising:
betaines.

7. The ink jet ink composition according to claim 6,
wherein a content of the betaines is 38 by mass or greater and 10% by mass or less with respect to the total mass of the ink jet ink composition.

8. The ink jet ink composition according to claim 1,
wherein the volume average particle diameter D50 of the self-dispersing pigment A is greater than the volume average particle diameter D50 of the self-dispersing pigment B.

9. The ink jet ink composition according to claim 1,
wherein the ink jet ink composition is used for recording on an absorbing recording medium.

10. A recording method comprising:
jetting the ink jet ink composition according to claim 1 from an ink jet head to make the ink jet ink composition adhere to a recording medium.
